(19) United States
(12) Patent Application Publication
(10) Pub. No.: US 2022/0278946 A1
(43) Pub. Date: Sep. 1, 2022

(54) PROGRAMMABLE PACKET PROCESSING PIPELINE WITH OFFLOAD CIRCUITRY

(71) Applicant: Intel Corporation, Santa Clara, CA (US)

(72) Inventors: Madhusudana RAGHUPATRUNI, Bangalore (IN); Anil KUMAR, Bengaluru (IN); Abhishek MUNDRA, Bangalore (IN); Deepak KHANDELWAL, Bangalore (IN); Sanjay Padubidri, Bangalore (IN)

(21) Appl. No.: 17/742,342

(22) Filed: May 11, 2022

(51) Int. Cl. H04L 49/9005; H04L 49/9057; H04L 47/2416; H04L 47/20

(52) U.S. Cl. CPC H04L 49/9005; H04L 49/9057; H04L 47/2416; H04L 47/20

(57) ABSTRACT

Examples described herein relate to a network interface device. The network interface device can include a programmable packet processing pipeline and one or more offload circuitries. In some examples, configuration of operation of the programmable packet processing pipeline and the one or more offload circuitries is based on a program consistent with a programmable pipeline language.

### BACKGROUND

Programming Protocol-independent Packet Processors (P4) defines a programming language that configures processing of packets by data planes in devices such as switches, routers, and smart network interface controllers (smart NICs). Portable NIC Architecture (PNA) is a P4 architecture that defines the structure and common capability of a network interface that allows programs to be portable and executed across multiple NIC devices that are conformant with the PNA. PNA model has P4 programmable blocks and fixed function blocks, known as externs. The operation of the programmable blocks is configured using P4 compatible programs. However, operations of the fixed-function blocks are not programmed using P4 compatible programs.

### BRIEF DESCRIPTION OF THE DRAWINGS

FIG. 1 depicts an example system.

FIG. 2 depicts an example deployment model. Following diagram shows possible deployment combinations for a program.

FIG. 3 depicts an example of metadata.

FIG. 4 depicts an example format of appending metadata to a data as a header stack.

FIG. 5 depicts an example format of appending metadata to a data as header link list.

FIG. 6 depicts an example configuration of offload circuitries based on order of processing of a packet.

FIG. 7 depicts an example of routing of a packet to an offload circuitry.

FIG. 8 depicts an example process to form metadata.

FIG. 9 depicts an example system in which offload circuitries are configured to perform operations for PDCP.

FIG. 10 depicts an example system that can be used to implement PDCP user plane from a programmable pipeline and offload circuitries.

FIG. 11 depicts an example process.

FIG. 12 depicts an example network interface device.

FIG. 13 depicts a system.

### DETAILED DESCRIPTION

An instruction set based on a programmable pipeline language can configure operations of a programmable packet processing pipeline and offload circuitry (e.g., externs) as well as communications between one or more offload circuitries and the programmable packet processing pipeline and communications among one or more offload circuitries. A programmable packet processing pipeline can include one or more of: a parser, ingress packet processing pipeline to perform operations based on match-actions, traffic manager, egress packet processing pipeline to perform operations based on match-actions, or de-parser. Offload circuitry can include one or more of: application specific integrated circuit (ASIC), field programmable gate array (FPGA), graphics processing unit (GPU), or central processing unit (CPU). Offload circuitry can include or represent P4 externs in some examples.

For example, a programmable pipeline language can include P4, Software for Open Networking in the Cloud (SONiC), Broadcom® Network Programming Language (NPL), NVIDIA® CUDA®, NVIDIA® DOCA™, Infrastructure Programmer Development Kit (IPDK), among others. The program based on a programmable pipeline language can specify operation of physical or logical ports or interfaces ports to provide connections and routing for communications of metadata and data between offload circuitries and/or connections and routing between the programmable packet processing pipeline and one or more offload circuitries. A port or interface could connect to a dedicated offload circuitry or a set of chained offload circuitries. Connections specified by the configuration can specify interconnect topology, e.g., point-to-point, ring, mesh, or others.

The programmable packet processing pipeline can configure operation of one or more offload circuitries by providing a header or metadata prepended to data (e.g., one or more packets) based on the configuration in the program consistent with a programmable pipeline language. The header can include at least command and response fields. Offload circuitry can process one or more packets based on the command and provides results in the response field. Metadata can be prepended or embedded in one or more packets that are to be processed by the offload circuitry. Programmable packet processing pipeline can form an array or stack of metadata headers to configure offload circuitry according to order of operation.

Offload circuitries placed outside P4 pipeline are flexible and can be invoked from within programmable packet processing pipeline. Use of offload circuitries may not stall operation of the pipeline and may operate on one or more packets.

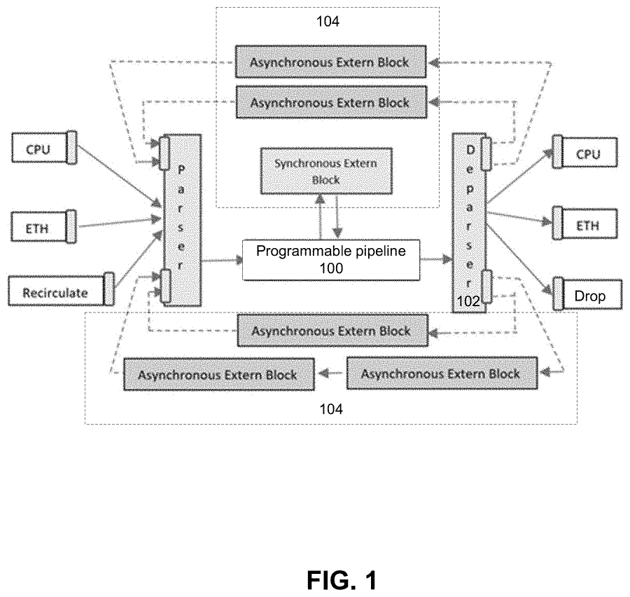

FIG. 1 depicts an example system. A parser can receive one or more packets from one or more of a central processing unit (CPU), network interface controller (e.g., Ethernet (ETH) interface), offload circuitry, or deparser. Parser can receive recirculated packet from deparser 102 to process again using programmable pipeline 100 or one or more offload circuitries 104. Programmable packet processing pipeline 100 can include one or more of: a parser, ingress packet processing pipeline to perform operations based on match-actions, traffic manager, egress packet processing pipeline to perform operations based on match-actions, or de-parser.

A developer can write a packet processing pipeline program that configures parser, pipeline 100, deparser 102, and specifies operations, order of operations, and communication topology of one or more offload circuitries to processes packets of a flow.

A programmable pipeline language instruction set can be compiled to configure types of target devices such as CPUs, GPUs, FPGAs, and/or ASICs. Based on an instruction set consistent with a programmable pipeline language, programmable pipeline 100 can perform table lookups to determine whether a packet is to be processed by particular offload circuitry 104 (e.g., Synchronous Extern Block or Asynchronous Extern Block). Programmable pipeline 100 can perform packet processing, header transforms, update stateful elements such as counters, meters, and registers, and optionally associate user-defined metadata with the packet.

In some examples, in response to receiving a packet, the packet is directed to an ingress pipeline where an ingress pipeline may correspond to one or more ingress ports. After passing through the selected ingress pipeline, the packet is sent to the traffic manager, where the packet is enqueued and placed in an output buffer. Traffic manager can dispatch the packet to the appropriate egress pipeline where an egress pipeline may correspond to one or more egress ports.

A traffic manager can include a packet replicator and output buffer. In some examples, the traffic manager may include other components, such as a feedback generator for sending signals regarding output port failures, a series of queues and schedulers for these queues, queue state analysis components, as well as additional components. The packet replicator of some examples may perform replication for broadcast/multicast packets, generating multiple packets to be added to the output buffer (e.g., to be distributed to different egress pipelines).

Ingress and egress pipeline processing can perform processing on packet data. In some examples, ingress and egress pipeline processing can be performed as a sequence of stages, with a stage performing actions in one or more match and action tables. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.).

Parser can receive a packet as a formatted collection of bits in a particular order, and parse the packet into its constituent header fields. In some examples, the parser can separate packet headers from the payload of the packet, and can send the payload (or the entire packet, including the headers and payload) directly to deparser 102 without passing through ingress or egress pipeline processing.

Deparser 102 can reconstruct a packet as modified by one or more packet processing pipelines and the payload can be received from a memory (e.g., internal memory). Deparser 102 can construct a packet that can be sent out over the physical network, or to the traffic manager.

Deparser 102 can configure one or more offload circuitries 104 to perform operations on data from programmable pipeline based on the programmable pipeline language instruction set. Programmable pipeline 100 can configure one or more offload circuitries 104 with one or more of: an image or executable file to perform, operations to be executed, order of operation execution, or communication topology (e.g., chained or branched). Some examples of offload circuitries 104 perform packet buffering, cryptographic operations (e.g., decryption or encryption), timer, packet segmentation, packet reassembly, or key-value store. Some examples offload circuitries perform incremental checksum, packet metering, etc. For example, offload circuitry 104 can perform processing on packets provided from a host to be transmitted to a network (e.g., Transmission Control Protocol (TCP), User Datagram Protocol (UDP), quick UDP Internet Connections (QUIC)) and packet received from a network to be provided to a host (e.g., decryption or encryption). Synchronous extern block of offload circuitry 104 can perform packet processing inline with processing by programmable pipeline 100. Offload circuitries 104 can perform processing of packets received from a network to be transmitted to a network or received from a host and to be provided to a host by recirculation through pipeline 100. Offload circuitries 104 can be implemented as one or more of: CPU, GPU, FPGA, and/or ASIC.

Multiple instances of an offload circuitry among offload circuitries 104 can be available to provide load balancing and reduce latency of processing by offload circuitry. An instance of an offload circuitry among offload circuitries 104 can be selected based on congestion control and an overload protection can be performed using queues or buffers.

In some examples, offload circuitry can include a hardware queue manager (HQM) and the HQM can be configured using a programmable pipeline language. HQM provides queue management offload functions. HQM provides a hardware managed system of queues and arbiters connecting producers and consumers. HQM includes enqueue circuitry to receive data (e.g., descriptors for example) from a plurality of producers. Enqueue circuitry can inserts the data into one of the queues internal to HQM for temporary storage during load balancing operations. In some examples, HQM can perform load balancing among other offload circuitries.

A packet processing program configuration can request operations to be performed by pipeline 100 and one or more offload circuitries 104. One or more offload circuitries 104 can be invoked by calling functions in the program. Offload circuitry objects can be manipulated by programs through application program interfaces (APIs). One or more offload circuitries 104 can be called from pipeline 100 in an asynchronous fashion. One or more offload circuitries 104 can be connected to pipeline through dedicated logical ports.

To configure operations, order of operations, and communication topology of one or more offload circuitries, deparser 102 can generate one or more metadata sets based on the packet processing pipeline program. The program can configure deparser 102 to generate and prepend one or more metadata sets or headers to packet to be processed by one or more offload circuitries. A developer can flexibly define header type and parsing mechanism. Metadata can include request message fields that include information for offload circuitry to process one or more packets. Metadata can include response message fields that include results of processing and other information available to a next offload circuitry block to process. For example, a crypto offload circuitry request might include fields such as security context index, offset and length of data to undergo crypto processing. A response field might include error codes if an operation is not a success.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow includes a same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

In some examples, the system of FIG. 1 can be part of a network interface device. A network interface device can be implemented as one or more of: a network interface controller (NIC), a remote direct memory access (RDMA)-enabled NIC, SmartNIC, router, switch, switch system on chip (SoC), forwarding element, infrastructure processing unit (IPU), or data processing unit (DPU).

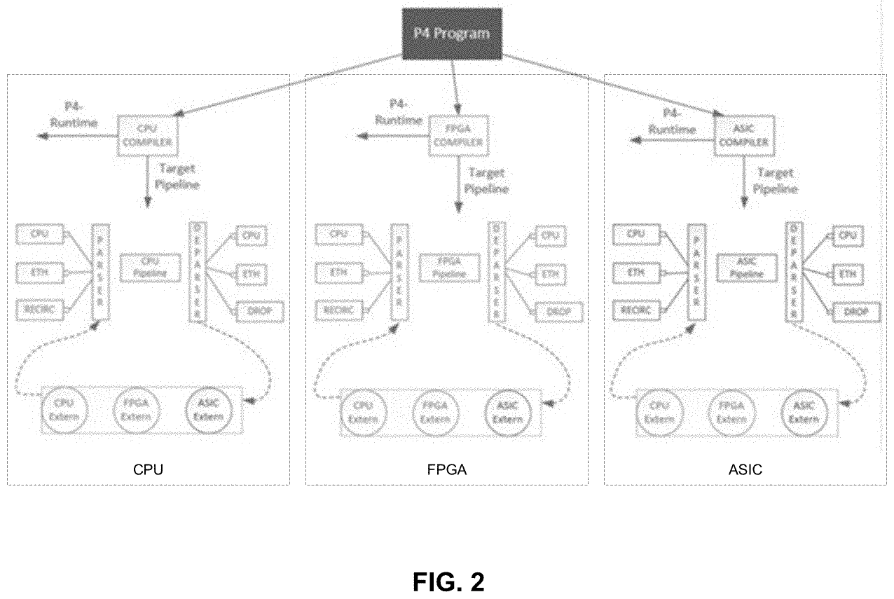

FIG. 2 depicts an example deployment model. A program can be written once and deployed in heterogeneous target implementations as the target can implement pipeline and offload circuitries as CPU, GPU, FPGA, and/or ASIC. Offload circuitries and pipelines can be implemented as hardware or software solutions based on network workloads throughput, capacity, power, and latency requirements.

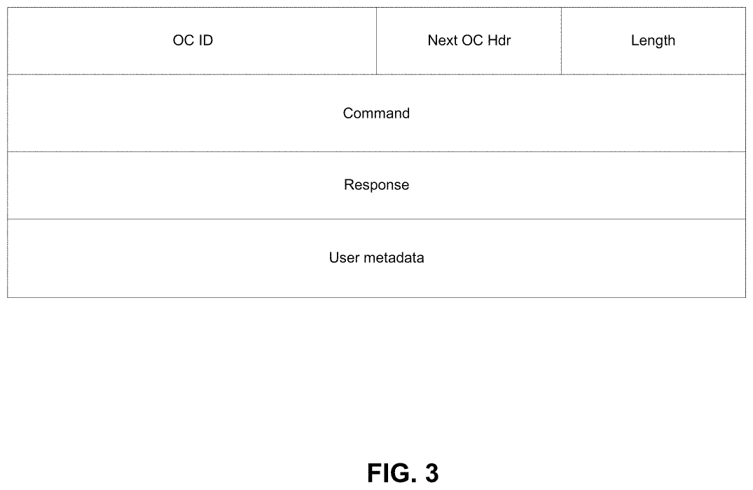

FIG. 3 depicts an example of metadata. A parser or packet processing pipeline can prepend or associate metadata with at least one packet to be processed by one or more offload circuitries. For example, metadata can be prepended to a packet as a second header to the packet. Metadata can include one of more fields described in Table 1.

TABLE 1

| Field name | Example description |
|---|---|
| Offload circuitry (OC) | Packet buffer Identifier. Can be used by the extern to |
| identifier (ID) | identify whether this metadata should be processed or |
| | skipped. If this extern ID does not match with the processing |
| | extern, it skips to the next extern header using length field. |
| Next OC Hdr (header) | A next OC/extern identifier in pipeline chain. If this field is |
| | a valid identifier, it skips to the next header. If this is an |
| | invalid value, an end of prepend header stack is reached. |
| Length | Prepend header length for the current extern (e.g., packet |
| | buffer extern PPH length). Can be used by the extern to |
| | reach to the end of the current header or start of the next |
| | header. |
| Command | Operations to be performed by offload circuitry (e.g., cipher, |
| | decipher, enqueue, dequeue, discard). An operation |
| | includes associated parameters in this section of the prepend |
| | header space defined by the extern header. |
| Response | Part of prepend header space which is writable by the extern. |
| | Can include operation status and error codes if applicable |
| | (e.g., success/failure etc.) Additional return values for the |
| | operation performed. |
| User metadata | Packet flow specific metadata which is available in pipeline |
| | parser post extern processing. This metadata can be |
| | consumed by the pipeline or extern if relevant. |

In some examples, processing of data or packets from a pipeline includes processing by multiple offload circuitries. For example, a first offload circuitry could process data (e.g., packet) by performing crypto decryption, a second offload circuitry can buffer data for out-of-sequence reconstruction, and a third offload circuitry can perform a timer for packet buffer protection against buffer overflow. Operations of three offload circuitries can be in a chain, namely, cryptography, packet buffer, and then timer. Three metadata or headers can be provided as a sequence with the data for configuring the offload circuitries. The metadata and data can be provided to the offload circuitries through a logical port connected to the pipeline or an offload circuitry can route metadata and data to a next offload circuitry in the sequence of metadata.

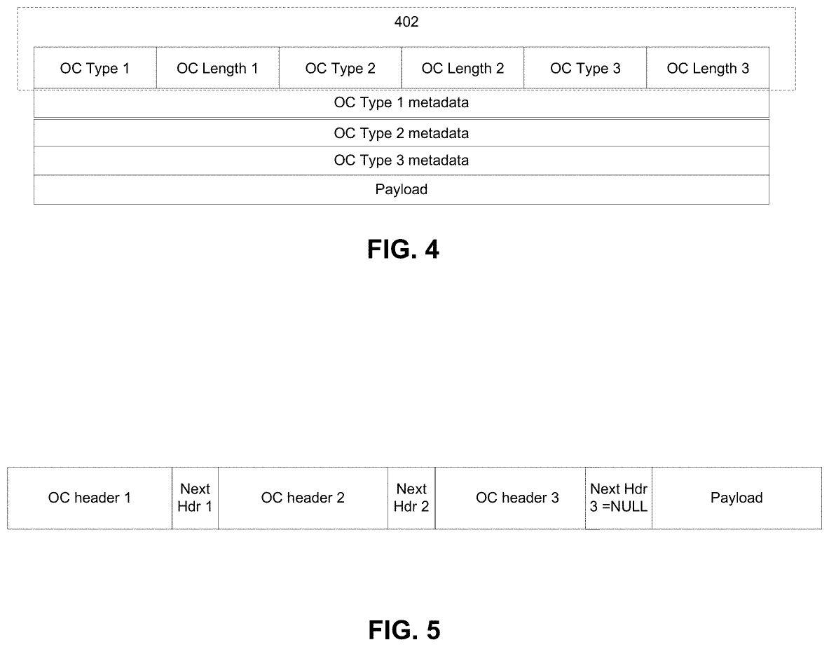

FIG. 4 depicts an example format of appending metadata to a payload as a header stack. Type-length-value (TLV) format can be used to identify types and locations of multiple metadata. Multiple metadata can configure operations and receive responses from multiple offload circuitries. TLV header 402 can identify offload circuitry (OC) type and length of its metadata. For example, OC type 1 can indicate a type of operation for a first offload circuitry to perform (e.g., crypto) whereas OC length 1 can indicate an offset from start of metadata at which OC Type 1 metadata begins. Similarly, OC type 2 can indicate a type of operation for a second offload circuitry to perform (e.g., packet buffer) whereas OC length 2 can indicate an offset from start of metadata at which OC Type 2 metadata begins. OC type 3 can indicate a type of operation for a third offload circuitry to perform (e.g., timer) whereas OC length 3 can indicate an offset from start of metadata at which OC Type 3 metadata begins. Header 402 can be prepended to payload (e.g., data or one or more packets). An offload circuitry can determine an offset of its header from header 402 to determine location of metadata.

In some examples, metadata and/or payload can be encrypted to restrict access to metadata and/or payload to permitted offload circuitry. Instead of a payload, other examples may include a pointer to a memory address of the payload. A payload (e.g., packet) can be stored in host memory (e.g., high bandwidth memory (HBM)) or internal memory (e.g., static random access memory (SRAM)).

FIG. 5 depicts an example format of appending metadata to a payload. OC headers 1-3 can be a format depicted in FIG. 3. Next header (Hdr) field 1 can indicate a presence of OC header 2 after Next header field 1. Next header field 2 can indicate a presence of OC header 3 after Next header field 2. Next header field 3 value of null can indicate payload follows Next header field 3.

Metadata order can indicate a processing sequence of a packet by offload circuitries. In the examples of FIGS. 4 and 5, after pipeline processing, one or more packets are processed by offload circuitry 1, then offload circuitry 2, and then offload circuitry 3. Offload circuitry 3 can transfer the processed packet to the packet processing pipeline, provide the processed packet to a host, or cause transmission of the processed packet to a network depending on configuration in metadata or control plane configuration.

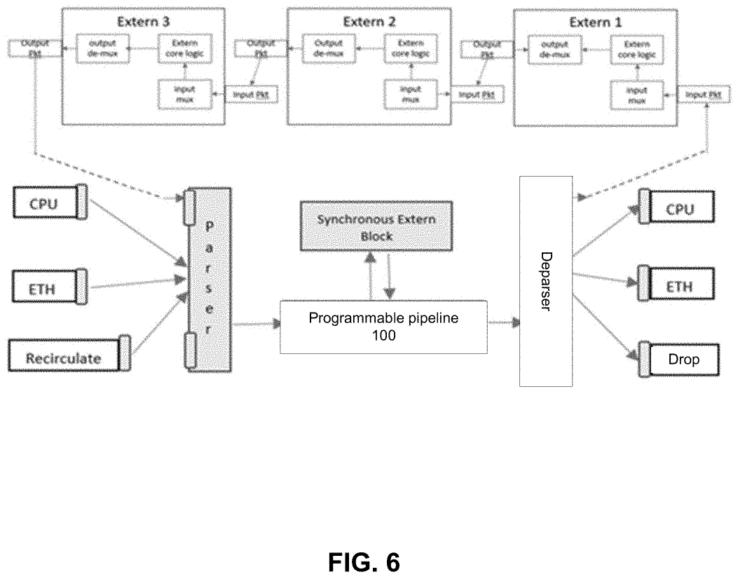

FIG. 6 depicts an example configuration of offload circuitries based on order of processing of a packet. A pipeline program can define configurations of offload circuitries to perform operations in an order. Interconnect technologies such as a switch, ring, crossbar, or others can be used to provide communication among pipeline and offload circuitries and among offload circuitries. In this example, offload circuitries, corresponding to externs 1-3, process a packet from pipeline in order of extern 1, extern 2, and extern 3. Pipeline 100 can provide metadata that configure operations of externs 1-3 as described herein. For example, extern 1 can process a packet by performing L4 checksum, extern 2 can process the packet by performing buffering, and extern 3 can process the packet by performing cryptographic operation or hash.

In an extern circuitry, input multiplexer can extract the metadata for the extern and the metadata to offload circuitry core logic circuitry to perform processing of the packet as specified by the metadata. Metadata can include request and response fields. The core logic circuitry is to perform the operations specified in the request field and fill-in the response fields with the result of operation including error codes and the return values. Processed packet data can be provided to output demultiplexer logic circuitry. Output de-multiplexer logic circuitry can provide the processed packet with the updated response field in the metadata.

An offload circuitry can be assigned a unique identifier in order to identify offload circuitry that is to receive metadata and packet. For example, metadata can identify extern 1 is to process the data, followed by extern 2, and followed by extern 3. Intermediate routing switches can communicatively couple externs to one another and route the data to a next extern based on the routing in the metadata. Intermediate routing switches may be configured to provide routes with offload circuitry ID as lookup parameter and port as output.

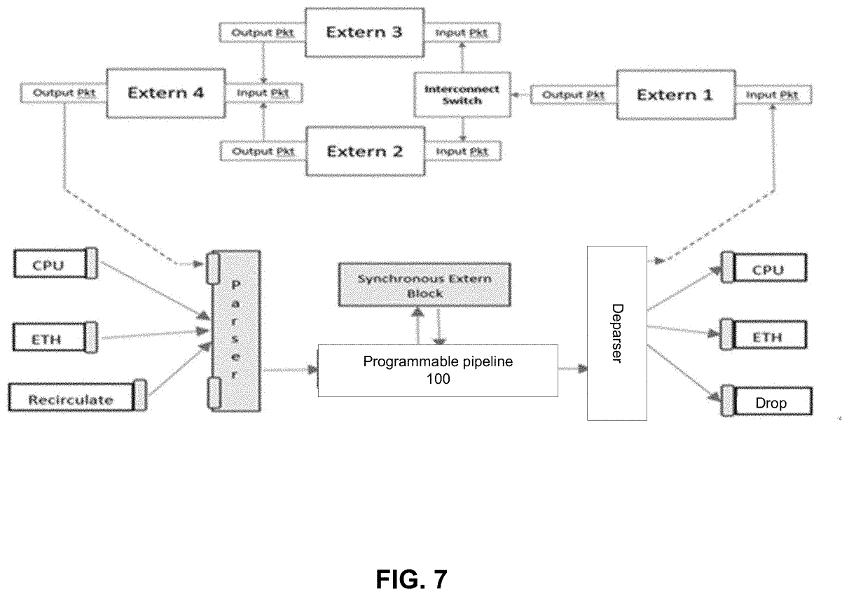

FIG. 7 depicts an example of routing of a packet to an offload circuitry. In this example, offload circuitry 1 (extern 1) can provide metadata and data to two offload circuitries, offload circuitry 2 (extern 2), and offload circuitry 3 (extern 3). An interconnect switch can connect an output port of extern 1 to route metadata and data to extern 2 or extern 3, based on metadata identifying offload extern 2 or extern 3 as a next extern to process the data. After processing of data by extern 2 or extern 3, data can be presented to offload circuitry 4 (extern 4) for processing. Thereafter, data processed by offload circuitry 4 can be provided to parser for recirculation to pipeline. The data (e.g., packet) can be sent to CPU, sent to a network (Ethernet (ETH)), or dropped.

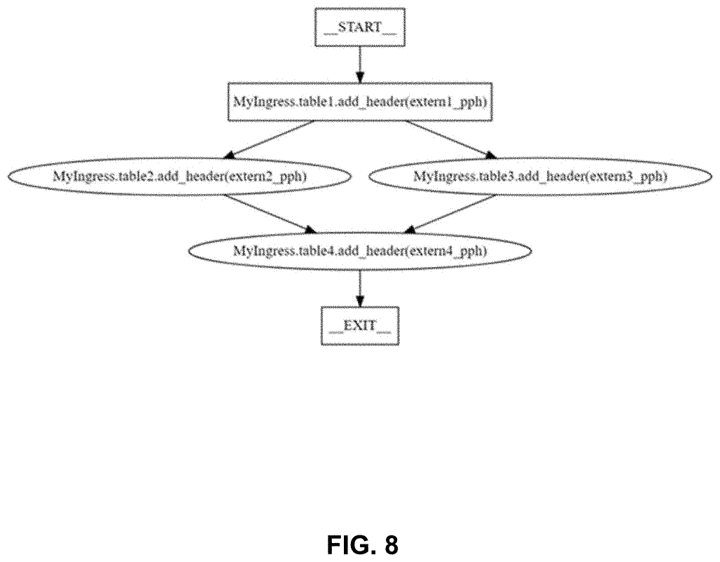

FIG. 8 depicts an example process to form metadata to define progress of data through the offload circuitry 1, to offload circuitry 2 or 3, and then to offload circuitry 4. Out of available offload circuitry, programmable pipeline logic based on the packet flow and the state determines which OCs are required to be executed in a specific order.

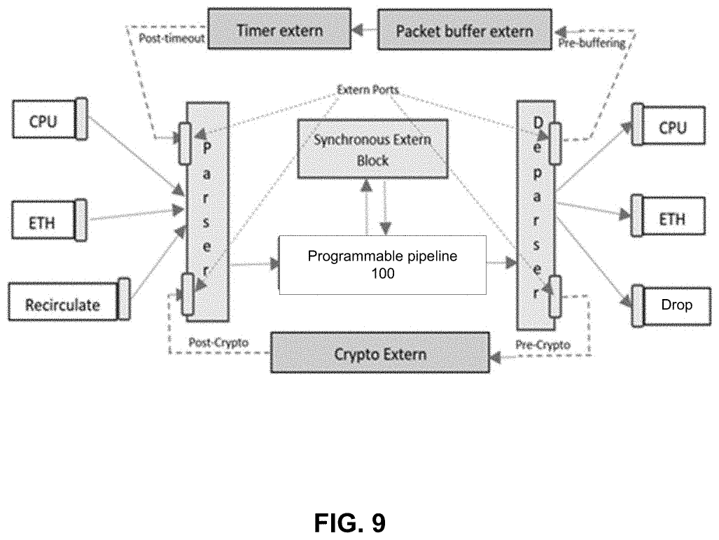

Packet Data Convergence Protocol (PDCP) is specified by 3GPP in TS 25.323 for UMTS (2004), TS 36.323 for Long Term Evolution (LTE) (2009) and TS 38.323 for 5G (2020). PDCP utilizes integrity protection and verification, ciphering/deciphering, in-order packet delivery and duplicate packet discards based on sequence numbers, and retransmission packet buffers and timer-based packet discards. To implement various PDCP operations, offload circuitries can perform: crypto offload circuitry (e.g., cipher, decipher, integrity protection and verification operations), packet buffer offload circuitry for packet reorder (e.g., in-order delivery) buffering, transmission buffering, timer offload circuitry to support per context timers and per packet timers. FIG. 9 depicts an example system in which offload circuitries are configured to perform operations for PDCP.

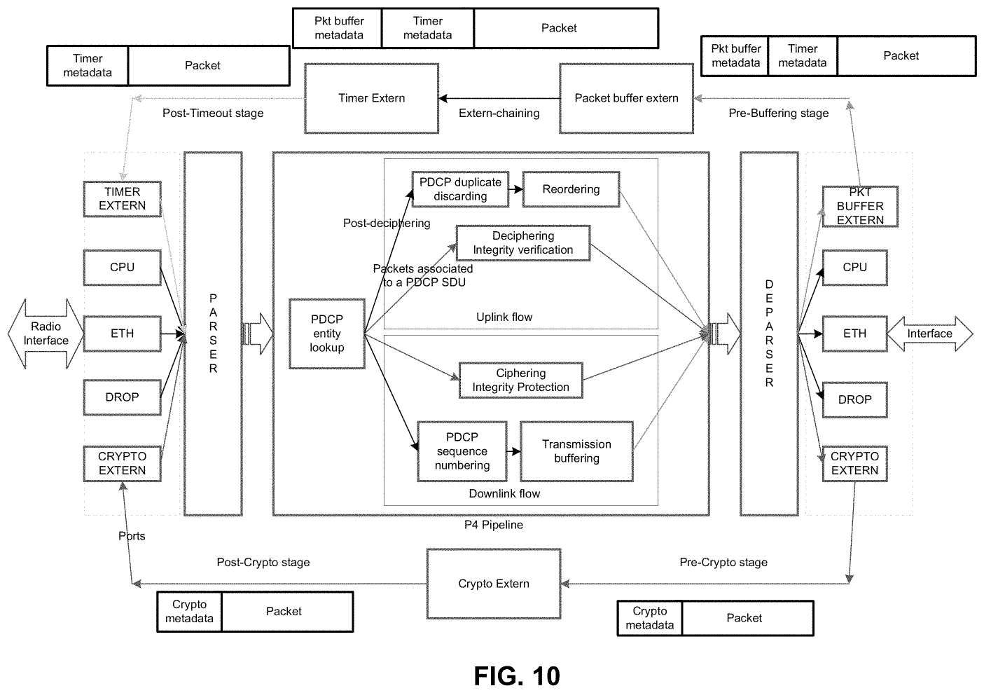

PDCP user plane implementation utilizes parsing and match action tables for PDCP entities and maintains state of reordering variables for in-order delivery to the transport layer in this case. Session-oriented protocols employ functions such as anti-replay window or duplicate detection and discard to protect system from Denial-of-service (DoS) attacks. These stateful functions support key-value stores performed by offload circuitry. FIG. 10 depicts an example system that can be used to implement PDCP user plane by configuration of a programmable pipeline and offload circuitries.

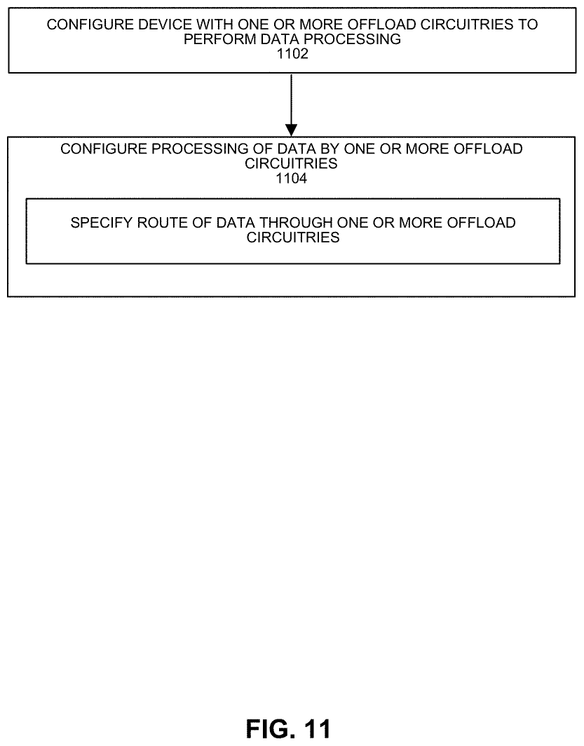

FIG. 11 depicts an example process. The process can be performed by a device with a programmable pipeline circuitry and one or more offload circuitry devices connected thereto. At 1102, configure device with a programmable pipeline circuitry and one or more offload circuitry devices based on a configuration in a programmable pipeline program. The configuration in a programmable pipeline program can be written by a software developer to configure a network interface device to process packets for particular use cases. The programmable pipeline configuration program can be in compiled format in some examples, such as machine readable, binary, or image files. Example formats of programmable pipeline configuration program include P4, SONiC, C, Python, Broadcom® Network Programming Language (NPL), NVIDIA® CUDA®, NVIDIA® DOCA™, Infrastructure Programmer Development Kit (IPDK), x86 compatible executable binaries or other executable binaries.

At 1104, utilization of one or more offload circuitries by the programmable pipeline circuitry can be configured by the configuration in a programmable pipeline program. For example, execution of the configuration in a programmable pipeline program can cause the programmable pipeline circuitry to generate metadata to control processing of data by the one or more offload circuitries. In some examples, the metadata can specify routing of data to a sequence of one or more offload circuitries as well as operations for one or more offload circuitries to perform so that the one or more offload circuitries are configured with image files or executable instructions to perform the associated operations on one or more packets. In some examples, the metadata can specify a route of data through one or more offload circuitries.

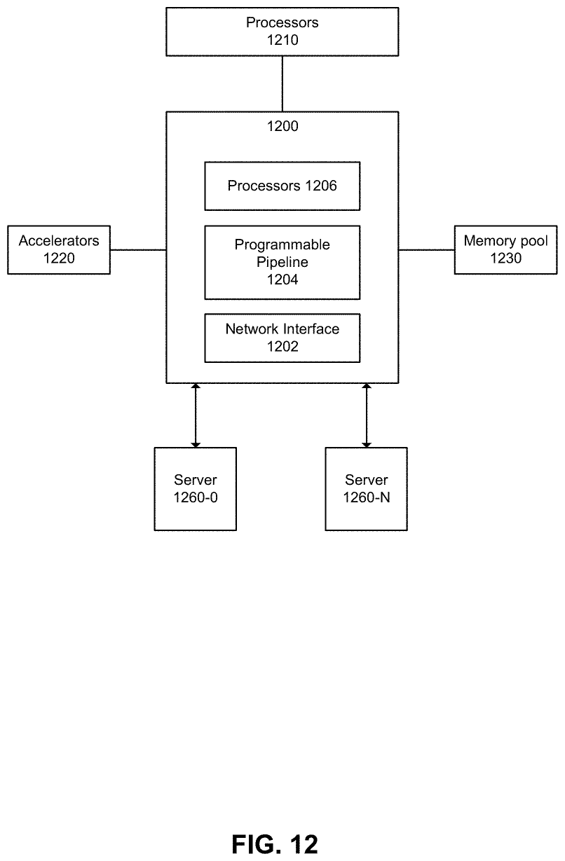

FIG. 12 depicts an example network interface device. In this system, network interface device 1200 manages performance of one or more processes using one or more of processors 1206, processors 1210, accelerators 1220, memory pool 1230, or servers 1240-0 to 1240-N, where N is an integer of 1 or more. In some examples, processors 1206 of network interface device 1200 can execute one or more processes, applications, VMs, microVMs, containers, microservices, and so forth that request performance of workloads by one or more of: processors 1210, accelerators 1220, memory pool 1230, and/or servers 1240-0 to 1240-N. Network interface device 1200 can utilize network interface 1202 or one or more device interfaces to communicate with processors 1210, accelerators 1220, memory pool 1230, and/or servers 1240-0 to 1240-N.

Network interface device 1200 can utilize programmable pipeline 1204 to process packets that are to be transmitted from network interface 1202 or packets received from network interface 1202. Programmable pipeline 1204, processors 1206, accelerators 1220 can include a programmable processing pipeline or offload circuitries that is programmable by P4, SONiC, C, Python, Broadcom Network Programming Language (NPL), NVIDIA® CUDA®, NVIDIA® DOCA™, Infrastructure Programmer Development Kit (IPDK), x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. As described herein, operations and connections of programmable pipeline 1204 and/or processors 1206 can be configured by an instruction set based on a programmable pipeline language.

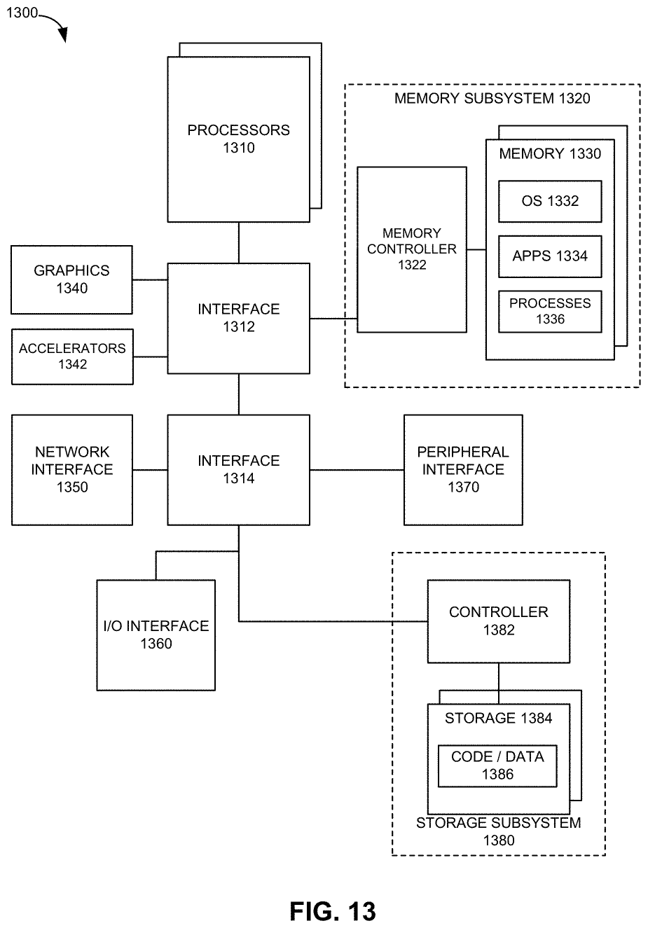

FIG. 13 depicts an example computing system. Operations and connections of components and sub-components of system 1300 (e.g., processor 1310, memory controller 1322, graphics 1340, accelerators 1342, network interface 1350, controller 1382, and so forth) can be configured by an instruction set based on a programmable pipeline language, as described herein. System 1300 includes processor 1310, which provides processing, operation management, and execution of instructions for system 1300. Processor 1310 can include any type of microprocessor, central processing unit (CPU), graphics processing unit (GPU), processing core, or other processing hardware to provide processing for system 1300, or a combination of processors. Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1300 includes interface 1312 coupled to processor 1310, which can represent a higher speed interface or a high throughput interface for system components that needs higher bandwidth connections, such as memory subsystem 1320 or graphics interface components 1340, or accelerators 1342. Interface 1312 represents an interface circuit, which can be a standalone component or integrated onto a processor die. Where present, graphics interface 1340 interfaces to graphics components for providing a visual display to a user of system 1300. In one example, graphics interface 1340 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1340 generates a display based on data stored in memory 1330 or based on operations executed by processor 1310 or both. In one example, graphics interface 1340 generates a display based on data stored in memory 1330 or based on operations executed by processor 1310 or both.

Accelerators 1342 can be a fixed function or programmable offload engine that can be accessed or used by a processor 1310. For example, an accelerator among accelerators 1342 can provide compression (DC) capability, cryptography services such as public key encryption (PKE), cipher, hash/authentication capabilities, decryption, or other capabilities or services. In some embodiments, in addition or alternatively, an accelerator among accelerators 1342 provides field select controller capabilities as described herein. In some cases, accelerators 1342 can be integrated into a CPU socket (e.g., a connector to a motherboard or circuit board that includes a CPU and provides an electrical interface with the CPU). For example, accelerators 1342 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1342 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1320 represents the main memory of system 1300 and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

In some examples, OS 1332 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, Broadcom®, Nvidia®, IBM®, Texas Instruments®, among others.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1300 includes interface 1314, which can be coupled to interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can transmit data to a device that is in the same data center or rack or a remote device, which can include sending data stored in memory. Network interface 1350 (e.g., packet processing device) can execute a virtual switch to provide virtual machine-to-virtual machine communications for virtual machines (or other virtual environments) in a same server or among different servers. Operations and connections of network interface 1350 with offload circuitry (e.g., processors 1310, accelerators 1342, and others) can be configured by an instruction set based on a programmable pipeline language, as described herein.

Some examples of network interface 1350 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (e.g., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (e.g., the value or state of the data is indeterminate if power is interrupted to system 1300). In one example, storage subsystem 1380 includes controller 1382 to interface with storage 1384. In one example controller 1382 is a physical part of interface 1314 or processor 1310 or can include circuits or logic in both processor 1310 and interface 1314.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 1300. More specifically, power source typically interfaces to one or multiple power supplies in system 1300 to provide power to the components of system 1300. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1300 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as Non-volatile memory express (NVMe) over Fabrics (NVMe-oF) or NVMe.

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”'

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising: a programmable packet processing pipeline and one or more offload circuitries, wherein configuration of operation of the programmable packet processing pipeline and the one or more offload circuitries is based on a program consistent with a programmable pipeline language.

Example 2 includes one or more examples, wherein the programmable packet processing pipeline comprises one or more of: a central processing unit (CPU), application specific integrated circuit (ASIC), field programmable gate array (FPGA), or graphics processing unit (GPU).

Example 3 includes one or more examples, wherein the programmable packet processing pipeline comprises one or more of: a parser, at least one ingress packet processing pipeline to perform operations based on match-actions, traffic manager, at least one egress packet processing pipeline to perform operations based on match-actions, or de-parser.

Example 4 includes one or more examples, wherein the offload circuitry comprises one or more of: a central processing unit (CPU), application specific integrated circuit (ASIC), field programmable gate array (FPGA), or graphics processing unit (GPU).

Example 5 includes one or more examples, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

Example 6 includes one or more examples, wherein the programmable packet processing pipeline is to generate metadata associated with at least one packet and the metadata is to specify operation of the one or more offload circuitries to process the at least one packet.

Example 7 includes one or more examples, wherein the metadata comprise one or more of: an identifier of an offload circuitry of the one or more offload circuitries, command to perform, or response to performance of the command.

Example 8 includes one or more examples, wherein the programmable packet processing pipeline is to prepend the metadata to at least one packet.

Example 9 includes one or more examples, wherein the programmable pipeline language is to specify a routing of at least one packet from the programmable packet processing pipeline to an offload circuitry of the one or more offload circuitries or from a first offload circuitry of the one or more offload circuitries to a second offload circuitry of the one or more offload circuitries.

Example 10 includes one or more examples, wherein the one or more offload circuitries perform one or more of: packet buffering, cryptographic operations, timer, packet segmentation, packet reassembly, or key-value store.

Example 11 includes one or more examples, wherein the network interface device comprises a switch system on chip (SoC).

Example 12 includes one or more examples, and includes one or more ports and at least one memory coupled to the switch system on chip (SoC).

Example 13 includes one or more examples, and includes at least one non-transitory computer-readable medium comprising instructions stored thereon, that if executed by one or more processors, cause the one or more processors to: configure operation of a programmable packet processing pipeline and one or more offload circuitries based on a program consistent with a programmable pipeline language, wherein the program includes a call to utilize offload circuitry or accelerator.

Example 14 includes one or more examples, wherein the programmable packet processing pipeline comprises one or more of: a parser, ingress packet processing pipeline to perform operations based on match-actions, traffic manager, egress packet processing pipeline to perform operations based on match-actions, or de-parser.

Example 15 includes one or more examples, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

Example 16 includes one or more examples, wherein the operation of the programmable packet processing pipeline comprises generate metadata associated with at least one packet and the metadata is to specify operation of the one or more offload circuitries to process the at least one packet.

Example 17 includes one or more examples, wherein the metadata comprise one or more of: an identifier of an offload circuitry of the one or more offload circuitries, command to perform, or response to performance of the command.

Example 18 includes one or more examples, wherein the operation of the programmable packet processing pipeline comprises specify a routing of at least one packet from the programmable packet processing pipeline to an offload circuitry of the one or more offload circuitries or from a first offload circuitry of the one or more offload circuitries to a second offload circuitry of the one or more offload circuitries.

Example 19 includes one or more examples, wherein the operation of the one or more offload circuitries comprises one or more of: packet buffering, cryptographic operations, timer, packet segmentation, packet reassembly, or key-value store.

Example 20 includes one or more examples, and includes a method comprising: configuring operation of a programmable packet processing pipeline and one or more offload circuitries based on a program consistent with a programmable pipeline language.

Example 21 includes one or more examples, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

Example 22 includes one or more examples, wherein the operation of the programmable packet processing pipeline comprises generate metadata associated with at least one packet and the metadata is to specify operation of the one or more offload circuitries to process the at least one packet.

What is claimed is:

1. An apparatus comprising:
a network interface device comprising:
a programmable packet processing pipeline and one or more offload circuitries, wherein configuration of operation of the programmable packet processing pipeline and the one or more offload circuitries is based on a program consistent with a programmable pipeline language.

2. The apparatus of claim 1, wherein the programmable packet processing pipeline comprises one or more of: a central processing unit (CPU), application specific integrated circuit (ASIC), field programmable gate array (FPGA), or graphics processing unit (GPU).

3. The apparatus of claim 1, wherein the programmable packet processing pipeline comprises one or more of: a parser, at least one ingress packet processing pipeline to perform operations based on match-actions, traffic manager, at least one egress packet processing pipeline to perform operations based on match-actions, or de-parser.

4. The apparatus of claim 1, wherein the offload circuitry comprises one or more of: a central processing unit (CPU), application specific integrated circuit (ASIC), field programmable gate array (FPGA), or graphics processing unit (GPU).

5. The apparatus of claim 1, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

6. The apparatus of claim 1, wherein the programmable packet processing pipeline is to generate metadata associated with at least one packet and the metadata is to specify operation of the one or more offload circuitries to process the at least one packet.

7. The apparatus of claim 6, wherein the metadata comprise one or more of: an identifier of an offload circuitry of the one or more offload circuitries, command to perform, or response to performance of the command.

8. The apparatus of claim 1, wherein the programmable packet processing pipeline is to prepend the metadata to at least one packet.

9. The apparatus of claim 1, wherein the programmable pipeline language is to specify a routing of at least one packet from the programmable packet processing pipeline to an offload circuitry of the one or more offload circuitries or from a first offload circuitry of the one or more offload circuitries to a second offload circuitry of the one or more offload circuitries.

10. The apparatus of claim 1, wherein the one or more offload circuitries perform one or more of: packet buffering, cryptographic operations, timer, packet segmentation, packet reassembly, or key-value store.

11. The apparatus of claim 1, wherein the network interface device comprises a switch system on chip (SoC).

12. The apparatus of claim 11, comprising one or more ports and at least one memory coupled to the switch system on chip (SoC).

13. At least one non-transitory computer-readable medium comprising instructions stored thereon, that if executed by one or more processors, cause the one or more processors to:
configure operation of a programmable packet processing pipeline and one or more offload circuitries based on a program consistent with a programmable pipeline language, wherein the program includes a call to utilize offload circuitry or accelerator.

14. The at least one computer-readable medium of claim 13, wherein the programmable packet processing pipeline comprises one or more of: a parser, ingress packet processing pipeline to perform operations based on match-actions, traffic manager, egress packet processing pipeline to perform operations based on match-actions, or de-parser.

15. The at least one computer-readable medium of claim 13, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

16. The at least one computer-readable medium of claim 13, wherein the operation of the programmable packet processing pipeline comprises generate metadata associated with at least one packet and the metadata is to specify operation of the one or more offload circuitries to process the at least one packet.

17. The at least one computer-readable medium of claim 16, wherein the metadata comprise one or more of: an identifier of an offload circuitry of the one or more offload circuitries, command to perform, or response to performance of the command.

18. The at least one computer-readable medium of claim 13, wherein the operation of the programmable packet processing pipeline comprises specify a routing of at least one packet from the programmable packet processing pipeline to an offload circuitry of the one or more offload circuitries or from a first offload circuitry of the one or more offload circuitries to a second offload circuitry of the one or more offload circuitries.

19. The at least one computer-readable medium of claim 13, wherein the operation of the one or more offload circuitries comprises one or more of: packet buffering, cryptographic operations, timer, packet segmentation, packet reassembly, or key-value store.

20. A method comprising:
configuring operation of a programmable packet processing pipeline and one or more offload circuitries based on a program consistent with a programmable pipeline language.

21. The method of claim 20, wherein the programmable pipeline language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

22. The method of claim 20, wherein the operation of the programmable packet processing pipeline comprises generate metadata associated with at least one packet and the metadata is to specify operation of the one or more offload circuitries to process the at least one packet.
